(19) United States
(12) Patent Application Publication
(10) Pub. No.: US 2026/0067997 A1
(43) Pub. Date: Mar. 5, 2026

(54) Susceptor

(71) Applicant: MiCo Ceramics Ltd., Anseong-si (KR)

(72) Inventor: Jung-Chul Jin, Anseong-si, Gyeonggi-do (KR)

(21) Appl. No.: 19/315,955

(22) Filed: Sep. 2, 2025

(30) Foreign Application Priority Data
Sep. 5, 2024 (KR) 10-2024-0120789

(51) Int. Cl. H05B 3/18; H05B 3/26

(52) U.S. Cl. CPC H05B 3/18; H05B 3/265; H05B 2203/007

(57) ABSTRACT

Provided is a ceramic susceptor including an insulation plate on which a first heating element of a first layer and a second heating element of a second layer are arranged and stacked, wherein the first heating element is located between and connected to a pair of first terminals, and the second heating element is located between and connected to a pair of second terminals, the first heating element includes multiple concentric arc-shaped first resistance parts and first connection parts configured to connect the resistance parts at different diameter positions, and at least one of the first connection parts crosses a virtual line connecting the centers between both end portions of each of the first resistance parts.

### CROSS-REFERENCE TO RELATED APPLICATION(S)

This application is based on and claims priority under 35 U.S.C. 119 to Korean Patent Application No. 10-2024-0120789, filed on Sep. 5, 2024, in the Korean Intellectual Property Office, the disclosure of which is herein incorporated by reference in its entirety.

### BACKGROUND OF THE INVENTION

### 1. Field of the Invention

The present disclosure relates to a susceptor and specifically to a susceptor with a heater pattern applied thereto to improve temperature uniformity.

### 2. Description of the Prior Art

Generally, semiconductor devices or display devices are manufactured by sequentially stacking multiple thin film layers, including dielectric layers and metal layers, on a glass substrate, flexible substrate, or semiconductor wafer substrate, and then patterning same. The thin film layers are sequentially deposited on a substrate through a chemical vapor deposition (CVD) process or a physical vapor deposition (PVD) process. The CVD process includes a low pressure chemical vapor deposition (LPCVD) process, a plasma enhanced chemical vapor deposition (PECVD) process, a metal organic chemical vapor deposition (MOCVD) process, and the like. A CVD device and a PVD device include a ceramic susceptor arranged therein to support a glass substrate, a flexible substrate, a semiconductor wafer substrate, etc., and to generate a predetermined amount of heat or plasma generated by a radio frequency (RF) electrode. The ceramic susceptor is widely used in plasma deposition processes and other processes requiring precise temperature control and heat treatment for precision processes such as semiconductor element wire refinement, and is also used for plasma formation and substrate heating in etching processes of thin film layers formed on semiconductor wafer substrates and photoresist curing processes.

A general ceramic susceptor includes a heating element for heating functions arranged between ceramic materials. In a ceramic susceptor structure, the heating element receives power and generates heat to heat semiconductor wafer substrates or the like, and substrate temperature uniformity is important for improving yield through stable semiconductor processes.

FIGS. 1A and 1B are examples of plan views of a heating element pattern of a conventional ceramic susceptor.

First, referring to FIG. 1A, a conventional ceramic susceptor generally includes a heating element pattern 20 located between and connected to a pair of terminals 10a and 10b on an identical plane. One heating element pattern 20 is configured to define one heating zone.

In addition, referring to FIG. 1B, a conventional ceramic susceptor includes a heating element pattern 21 located between and connected to a pair of terminals 11a and 11b and a heating element pattern 22 located between and connected to a pair of terminals 12a and 12b on an identical plane. Each of the heating element patterns 21 and 22 is configured to define two different heating zones.

However, conventional ceramic susceptors have a problem in that symmetrical folding parts of the heating element pattern 20 in FIG. 1A cause a non-heating area 41 existing therebetween, thereby causing a cool zone on an upper surface of the susceptor where a substrate is placed and preventing a uniform temperature across the entire upper surface area.

In addition, as shown in FIG. 1B, conventional ceramic susceptors have a non-heating area 42 between the symmetrical folding parts of the heating element patterns 21 and 22 shown in FIG. 1b, and even if there is a straight connecting line part for connecting a pair of terminals 12a and 12b, and a resistive element of the heating element pattern 22 in the space between the folding parts, the straight connection part does not generate heat or generates only a small amount of heat. Therefore, a cool zone is generated on the upper surface of the susceptor where the substrate is placed, and the entire upper surface area does not have a uniform temperature.

### SUMMARY OF THE INVENTION

To address the aforementioned issues, the present disclosure provides a susceptor capable of improving temperature uniformity across the entire upper surface of the susceptor by configuring resistance parts of a main heating element in a concentric pattern to eliminate non-heating areas caused by symmetric folding parts of a heating element pattern, by applying a structure in which connection parts cross the spaces between resistance parts to reduce temperature deviations at locations of equal diameter from the center of the susceptor upper surface, and by configuring a compensation heating element additionally stacked on a different plane to compensate the temperature distribution.

To sum up the features of the present disclosure, a susceptor according to an aspect of the present disclosure to achieve the aforementioned purpose may include an insulation plate on which a first heating element of a first layer and a second heating element of a second layer are arranged and stacked, wherein the first heating element is located between and connected to a pair of first terminals, and the second heating element is located between and connected to a pair of second terminals, the first heating element includes multiple concentric arc-shaped first resistance parts and first connection parts connecting the resistance parts at different diameter positions, and at least one of the first connection parts may cross a virtual line connecting the centers between both end portions of each of the first resistance parts.

The second heating element may be arranged above or below the first heating element.

The second heating element may include a first compensation heating element extending in a diameter direction so that at least a portion of the first compensation heating element is stacked to overlap the first connection parts of the first heating element.

The first compensation heating element may include second resistance parts overlapping the first connection parts, and a second connection part located between and connected to the pair of second terminals and both ends of the second resistance part.

The second connection parts located between and connected to both ends of the second resistance part may have a straight or curved shape without folds.

The second heating element may include a second compensation heating element extending in a diameter direction so that at least a portion of the second compensation heating element is stacked to overlap the first connection parts of the first heating element, the second compensation heating element may include a third resistance part overlapping the first connection parts, and third connection parts located between and connected to the pair of second terminals and both ends of the third resistance part, and the third connection parts located between and connected to both ends of the third resistance part and the pair of second terminals may include a pattern having at least one fold.

The second heating element may include a third compensation heating element including multiple concentric arc-shaped fourth resistance parts and fourth connection parts connecting two concentric arc-shaped fourth resistance parts at different diameter positions among the multiple concentric arc-shaped fourth resistance parts.

Some of the concentric arc-shaped first resistance parts of the first heating element and the corresponding concentric arc-shaped fourth resistance parts of the third compensation heating element may be stacked to overlap each other in a band-shaped region within a predetermined diameter range of the susceptor.

A first virtual line connecting the centers between the both end portions of the first resistance parts of the first heating element and a second virtual line connecting the centers between the both end portions of the fourth resistance parts of the third compensation heating element may have at least a portion of each extending in different diameter directions.

The insulation plate may further include a third compensation heating element stacked on a third layer, and the third compensation heating element may include multiple concentric arc-shaped fourth resistance parts and fourth connection parts connecting two concentric arc-shaped fourth resistance parts at different diameter positions among the multiple concentric arc-shaped fourth resistance parts.

Some of the concentric arc-shaped first resistance parts of the first heating element and the corresponding concentric arc-shaped fourth resistance parts of the third compensation heating element may be stacked to overlap each other in a band-shaped region within a predetermined diameter range of the susceptor.

A first virtual line connecting the centers between the both end portions of the first resistance parts of the first heating element and a second virtual line connecting the centers between the both end portions of the fourth resistance parts of the third compensation heating element may have at least a portion of each extending in different diameter directions.

The insulation plate may further include a third compensation heating element stacked on a third layer, and the third compensation heating element may include multiple concentric arc-shaped fourth resistance parts and fourth connection parts connecting two concentric arc-shaped fourth resistance parts at different diameter positions among the multiple concentric arc-shaped fourth resistance parts.

The susceptor according to the present disclosure does not have a very long non-heating area (non-heating area between symmetrical folds in the heating element pattern) that normally generates two heating zones (2 zones), thereby improving temperature uniformity across the entire upper surface area of the susceptor and improving durability over long-term use of the susceptor.

Furthermore, the susceptor according to the present disclosure has a main heating element in an ideal concentric circle shape, which greatly reduces the possibility of temperature differences occurring between locations of the same diameter on the upper surface of the susceptor.

In addition, the susceptor according to the present disclosure compensates for temperature distribution by configuring a compensation heating element that is additionally stacked on a different plane from the main heating element and in this case, the susceptor may further improve temperature uniformity across the entire upper surface area of the susceptor by configuring additional temperature compensation heating elements in areas where there are connection parts connecting heating elements at different diameter positions in the main heating element, or in areas where the heat output is relatively low in the main heating element (generally, a middle section defining a band of a predetermined width in the middle in the diameter direction).

### BRIEF DESCRIPTION OF THE DRAWINGS

In order to help understanding of the present disclosure, the accompanying drawings which are included as a portion of the detailed description provide embodiments of the present disclosure and are provided to describe the technical features of the present disclosure together with the detailed description.

FIGS. 1A and 1B are examples of plan views of a heating element pattern of a conventional susceptor.

FIG. 2 is a schematic cross-sectional view of a susceptor according to an embodiment of the present disclosure.

FIG. 3A is a plan view of stacked heating elements of a first embodiment of the present disclosure, and FIGS. 3B and 3C are enlarged views of heating elements for each layer in an area with a low heat generation amount.

FIG. 4A is a plan view of stacked heating elements of a second embodiment of the present disclosure, and FIGS. 4B and 4C are enlarged views of heating elements for each layer in an area with a low heat generation amount.

FIG. 5A is a plan view of stacked heating elements of a third embodiment of the present disclosure, and FIGS. 5B and 5C are enlarged views of heating elements for each layer in an area with a low heat generation amount.

FIG. 6A is a plan view of stacked heating elements of a fourth embodiment of the present disclosure, and FIGS. 6B to 6D are enlarged views of heating elements for each layer in an area with a low heat generation amount.

FIG. 7A is a plan view of stacked heating elements of a fifth embodiment of the present disclosure, and FIGS. 7B to 7D are enlarged views of heating elements for each layer in an area with a low heat generation amount.

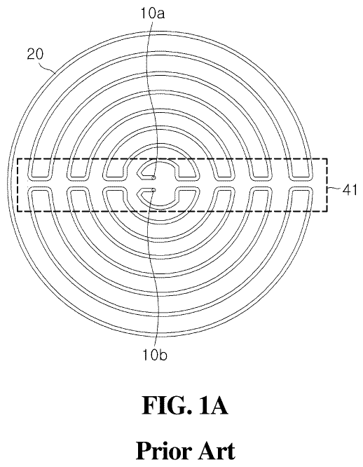

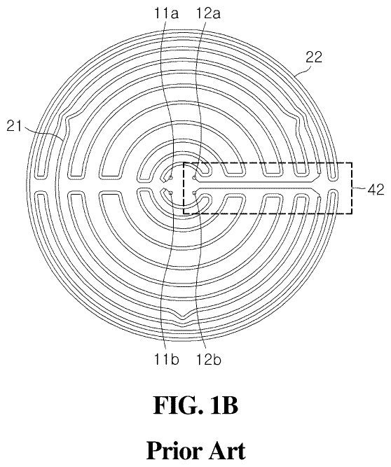

### DETAILED DESCRIPTION OF THE EXEMPLARY EMBODIMENTS

Hereinafter, the present disclosure will be described in detail with reference to the accompanying drawings. Here, the same components in each drawing are represented by the same reference numerals as possible. In addition, a detailed description of functions and/or configurations that are already known will be omitted. In a description below, a portion necessary for understanding operations according to various embodiments will be mainly described, and a description of an element that may obscure the gist of the description will be omitted. Furthermore, some components in the drawings may be exaggerated, omitted, or schematically illustrated. A size of each component does not entirely reflect an actual size, and therefore, contents described herein are not limited by a relative size or spacing of the components drawn in each drawing.

In describing embodiments of the present disclosure, if it is determined that a detailed description of the known technology related to the present disclosure may unnecessarily obscure the subject matter of the present disclosure, the detailed description will be omitted. The terms which will be described below are terms defined in consideration of the functions in the disclosure, and may be different according to users, intentions of the users, or customs. Therefore, the definitions of the terms should be made based on the contents throughout the specification. Terms used in the detailed description are only for describing the embodiments of the present disclosure, and should not be limiting. Unless explicitly stated otherwise, a singular form of an expression includes the meaning of a plural form. In this description, expressions such as “comprising” or “including” are intended to indicate certain features, numbers, steps, operations, elements, parts or combinations thereof, and one or more than those described and it should not be construed to exclude the existence or possibility of any other characteristic, number, step, operation, element, or part or combination thereof.

In addition, terms such as “first” and “second” may be used to describe various components, but the components are not limited by the terms, and the terms are used only for the purpose of distinguishing one component from another.

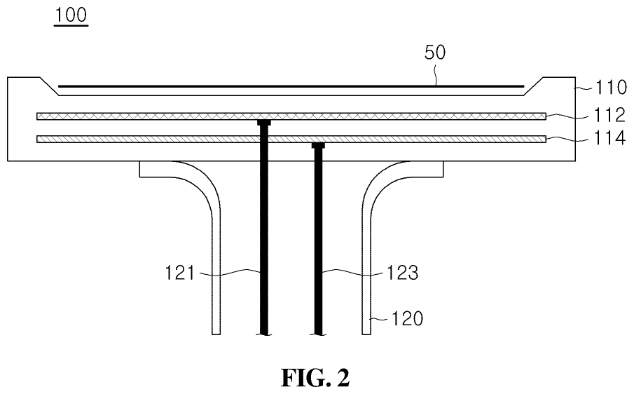

FIG. 2 is a schematic cross-sectional view of a susceptor 100 according to an embodiment of the present disclosure.

Referring to FIG. 2, the (ceramic) susceptor 100 according to an embodiment of the present disclosure includes an insulation plate 110 and a shaft 120.

The ceramic susceptor 100 according to an embodiment of the present disclosure corresponds to a semiconductive device configured to support various types of substrates to be processed, such as semiconductor wafers, glass substrates, and flexible substrates, and heat the substrates to be processed to a predetermined temperature. The ceramic susceptor 100 may also be used in semiconductor processes that utilize plasma, such as plasma-enhanced chemical vapor deposition or dry etching.

The insulation plate 110 may be configured so that a high-frequency electrode 112 for generating plasma and (or) a heating element 114 for heating a substrate are arranged (buried) at a predetermined interval with a ceramic material therebetween. The insulation plate 110 is configured to stably support a substrate 50 to be processed while enabling a semiconductor process using substrate heating using the heating element 114 and/or plasma using the high-frequency electrode 112.

In the ceramic susceptor 100 of the present disclosure, although not shown in the drawings, it is also possible to further arrange chuck electrode(s) having an electrostatic chuck function to support the substrate 50 placed on the insulation plate 110. For example, the chuck electrode(s) may be further configured to be spaced apart at predetermined intervals with a ceramic material interposed therebetween above or below the high-frequency electrode 112 or the heating element 114.

The insulation plate 110 may include a plate-like structure having a predetermined shape. For example, the insulation plate 110 may include a circular plate-like structure, but is not necessarily limited thereto. The ceramic material may correspond to at least one of Al₂O₃, Y₂O₃, Al₂O₃/Y₂O₃, ZrO₂, AIC (autoclaved lightweight concrete), TIN, AlN, TIC, MgO, CaO, CcO₂, TiO₂, B_xC_y, BN, SiO₂, SiC, YAG, mullite, or AlF₃, and preferably aluminum nitride (AlN). Furthermore, each ceramic powder may selectively include about 0.1 to 10%, preferably about 1 to 5%, of yttrium oxide powder.

A shaft 120 is a pipe type having a through-hole and is joined or coupled to the bottom surface of the insulation plate 110. The shaft 120 may be configured by ceramic identical to the insulation plate 110 and joined or coupled to the insulation plate 110.

The high-frequency electrode 112 or chuck electrode(s) may be made of tungsten (W), molybdenum (Mo), silver (Ag), gold (Au), niobium (Nb), titanium (Ti), aluminum nitride (AlN), or alloys thereof, and preferably molybdenum (Mo). The high-frequency electrode 112 may be connected to a radio frequency (RF) power source or grounded through a connection rod 121 embedded in the hollow shaft 120, and the chuck electrode(s) may be connected to a chuck electrode drive power source (DC or AC power source) through another connection rod embedded in the hollow shaft 120. The high-frequency electrode 112 has a wire type or sheet type mesh structure. Here, the mesh structure is a net-like structure in which multiple metals arranged in a first direction and multiple metals arranged in a second direction intersect each other.

The heating element 114 is made of tungsten (W), molybdenum (Mo), or an alloy or carbide thereof, and has a high melting point and high resistance. The heating element 114 may be configured as a coil, wire, or sheet using a heating wire (or a resistive wire or heating electrode). In addition, the heating element 114 may be configured as a multilayer structure for precise temperature control. This heating element 114 may be connected to a power source through a connection rod 123 provided in the shaft 120 in the semiconductor manufacturing process, and may perform a function of heating a substrate to be processed on the insulation plate 110 to a predetermined constant temperature in order to perform a smooth deposition process, etching process, and the like.

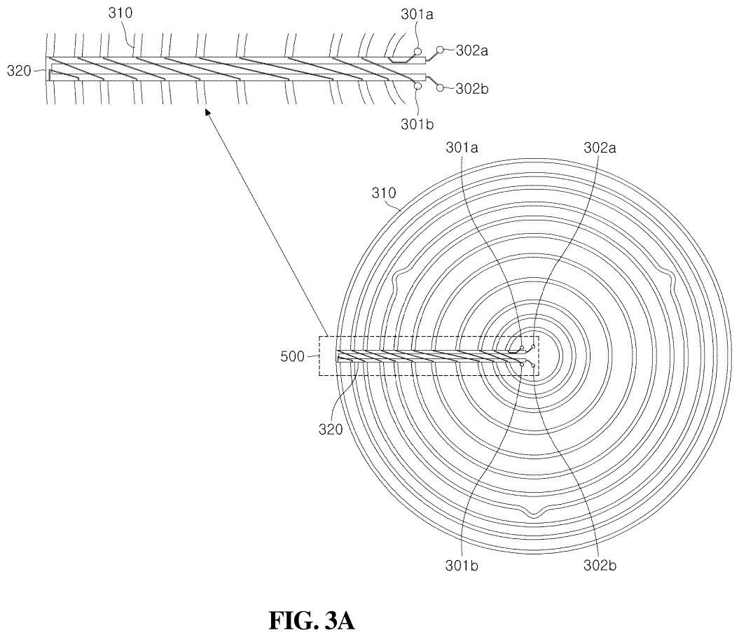

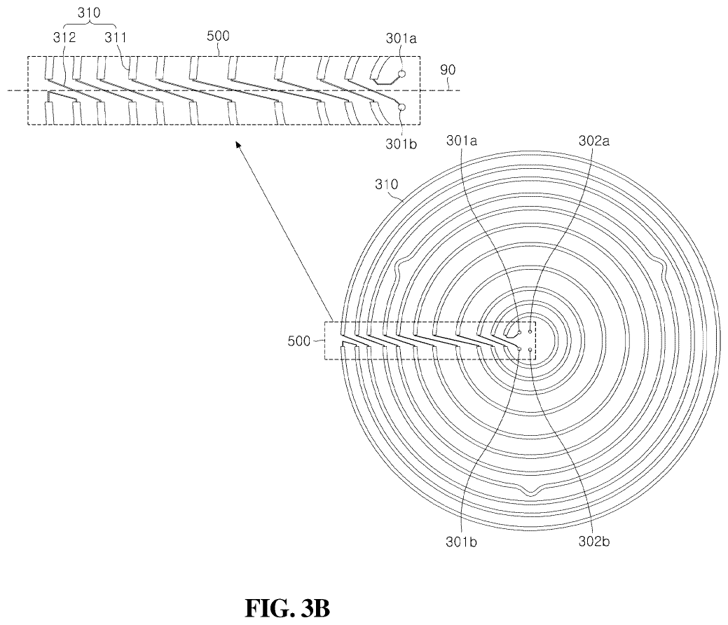

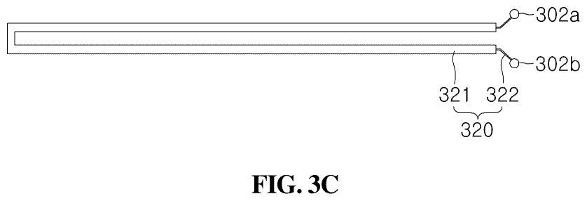

As shown in FIG. 3A to 7D, the susceptor 100 according to an embodiment of the present disclosure does not have a straight connection line parts (a connection part for connecting a terminal and a resistance part) of a very long non-heating area (non-heating area between symmetrical folds in the heating element pattern) in the heating element 114, which normally generates two heating zones (2 zones), thereby improving temperature uniformity across the entire upper surface area of the susceptor 100 and improving durability over long-term use of the susceptor 100. Furthermore, the susceptor 100 of the present disclosure has a main heating element (310 below) of the heating element 114 in an ideal concentric circle shape, which may significantly reduce the possibility of temperature differences occurring between locations of the same diameter on the upper surface of the susceptor 100. Furthermore, the susceptor 100 of the present disclosure configures a main heating element 310 and additional compensation heating elements (320, 330, and 340 below) stacked on a different plane (layer) to compensate for temperature distribution, and configures an additional temperature compensation heating element for an area (hereinafter referred to as 500) where straight connection line parts for connecting heating elements at different diameter positions exist in the main heating element 310, or for an area with relatively low heat generation in the main heating element 310 (mainly a middle part defining a band with a predetermined width in the diameter direction, the area between 610 and 620 below) to improve temperature uniformity across the entire upper surface area of the susceptor 100. The main heating element 310 corresponds to a first heating element in the claims, and the compensation heating elements 320, 330, and 340 correspond to a second heating element in the claims. In addition, as described below, the compensation heating elements 320, 330, and 340 include a first compensation heating element 320, a second compensation heating element 330, and a third compensation heating element 340.

The configuration of the present disclosure will be described in detail with reference to FIGS. 3A to 6D.

FIG. 3A is a plan view of stacked heating elements 310 and 320 of a first embodiment of the susceptor 100 of the present disclosure, and FIGS. 3B and 3C are enlarged views of heating elements 310 and 320 for each layer in an area 500 with a low heat generation amount. In the drawing, it is preferable that the main heating element 310 be placed in a layer higher than the first compensation heating element 320, but in some cases, it is also possible for the main heating element 310 to be placed in a layer lower than the first compensation heating element 320.

Referring to FIGS. 3A to 3C, the heating element 114 of the susceptor 100 may include the main heating element 310 of the first layer and the first compensation heating element 320 of the second layer, which are arranged (embedded) in a stacked structure with a ceramic material therebetween within the insulation plate 110.

The main heating element 310 corresponds to a heating element located between and electrically connected to the pair of first terminals 301a and 301b. The first compensation heating element 320 corresponds to a heating element located between and electrically connected to the pair of second terminals 302a and 302b.

The main heating element 310 may include multiple concentric arc-shaped first resistive elements 311 (the concentric arc-shaped resistive elements are resistance parts in which extension lines of arc portions configure a concentric circle, and are resistance parts in which a portion of a circle is broken, and the same applies hereinafter), and may include first connection parts 312 for connecting two concentric arc-shaped first resistance parts at different diameter positions (positions with different diameters from the center of the susceptor 100 or the insulation plate 110) among the multiple concentric arc-shaped first resistance parts 311. For example, the two concentric arc-shaped first resistance parts may include an n-th (n is a natural number) concentric arc-shaped first resistance part and an (n+2)th concentric arc-shaped first resistance part from the inner side (n=1, 2, 3 . . . ). The two concentric arc-shaped first resistance parts may include an n-th and (n+1)th concentric arc-shaped first resistance part in the outermost portion. Accordingly, by connecting the outermost arc-shaped resistance part to an adjacent arc-shaped resistance part, each arc-shaped resistance part may be electrically connected to configure a single heating zone by the main heating element 310.

It is desirable that a first virtual line 90 crossed by the first connection parts 312 extends in the diameter direction from the center of the insulation plate 110. The first virtual line 90 may correspond to a virtual line connecting the centers between the both end portions of concentric arc-shaped resistance parts 311 having the same diameter. The first virtual line 90 is not limited to a straight line, but may also be a bent line or a curved line, depending on the circumstances (the same applies below). The first connection parts 312 are configured obliquely with respect to the diameter direction and intersect a virtual line 90 connecting the centers between both end portions of the concentric arc-shaped resistance parts 311 having the same diameter. Accordingly, a space between both end portions of the concentric arc-shaped resistance parts 311 connected to the first connection parts 312 and a space including a portion therearound generate an area 500 with a relatively low heat generation amount.

In the present disclosure, due to the “connection parts” connecting the “n-th concentric arc-shaped resistance part” and the “(n+2)th concentric arc-shaped resistance part” among two concentric arc-shaped elements at different diameter positions, the connection parts cross the virtual line 90, thereby preventing the temperature from dropping in the space between the both end portions of the arc-shaped resistance parts 311 and reducing temperature deviation. In other words, due to the aforementioned structure, there are no non-heating areas between the symmetrical folds of the conventional heating element pattern, thereby improving temperature uniformity across the entire upper surface area of the susceptor.

The first compensation heating element 320 may be arranged to be stacked above or below the main heating element 310 in the area 500 where the heat output is relatively low compared to the main heating element 310. As such, the first compensation heating element 320 has a portion extending in the diameter direction so that at least a part thereof overlaps and is stacked with the first connection part 312 of the main heating element 310.

The first compensation heating element 320 includes a second resistance part 321 which is stacked on and overlaps the first connection parts 312 of the main heating element 310, and includes a second connection part 322 electrically connected to the pair of second terminals 302a and 302b and the both ends of the second resistance part 321. Both ends of the second resistance part 321 are brought as close as possible, for example, within a predetermined distance such as 1 cm or 2 cm, to the pair of second terminals 302a and 302b, which are close to each other within a predetermined distance such as 1 cm or 2 cm, and each second connection part 322 at both ends of the second resistance part 321 is connected in a straight line or curved line (e.g., a curve is possible without a bend of 90 degrees or more) without folding.

In this specification, the resistance part is a part in which the resistance is increased by increasing a distance traveled by electrons by processing the material for the heating element 114 into a coil shape (e.g., three-dimensional shape), and in this specification, the connection part is a part made of a material identical to that of the heating element 114 and corresponds to a connection line (e.g., a two-dimensional shape such as lines or stripes) for electrical connection. The resistance part is preferably implemented in a coil shape (e.g., a three-dimensional shape) as described above, but in some cases, the resistance part may also be implemented in a wire shape, sheet shape, and the like (e.g., a two-dimensional shape). In addition, the connection part is preferably implemented in a line or stripe shape (e.g., a two-dimensional shape), but in some cases, the connection part may also be implemented in a coil shape, wire shape, sheet shape, and the like.

Similarly, unless otherwise specified, the same concept applies to the resistance part and the connection part.

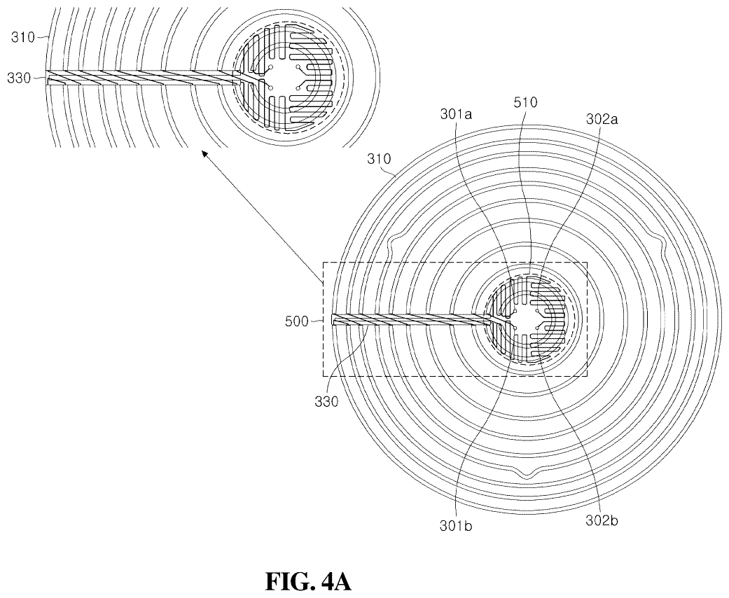

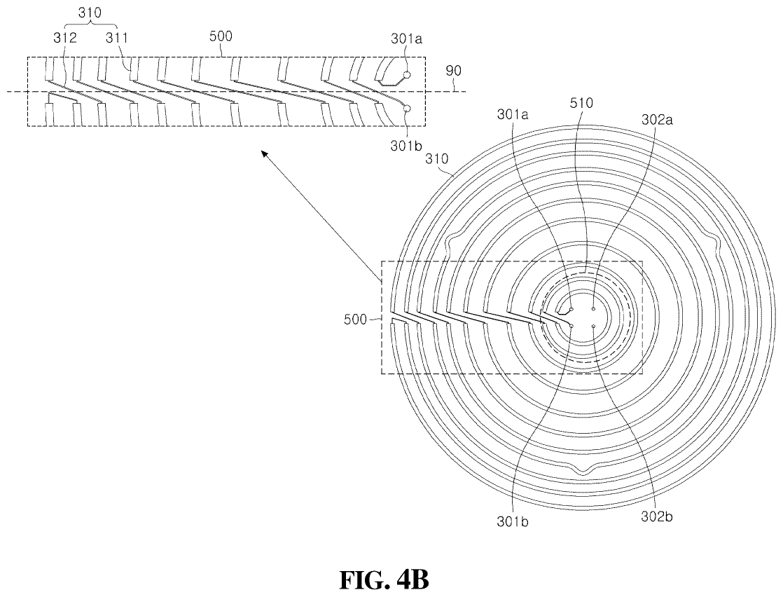

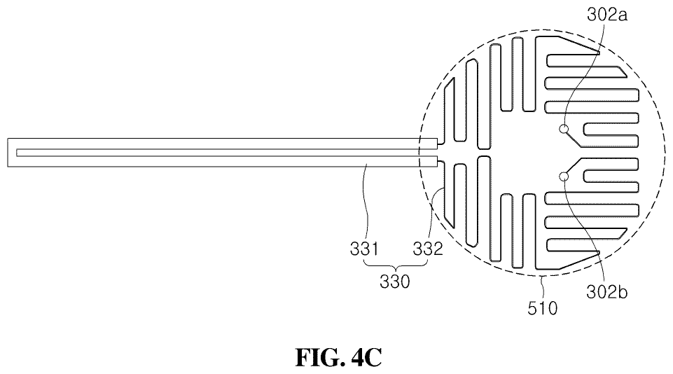

FIG. 4A is a plan view of stacked heating elements 310 and 330 of a second embodiment of the present disclosure, and FIGS. 4B and 4C are enlarged views of heating elements 310 and 330 for each layer in an area 500 or 510 with a low heat generation amount. In the drawing, it is preferable that the main heating element 310 be placed in a layer higher than the second compensation heating element 330, but in some cases, it is also possible for the main heating element 310 to be placed in a layer lower than the second compensation heating element 330. A third resistance part 331 of the second compensation heating element 330 is similar to the second resistance part 321 of the first compensation heating element 320 in FIG. 3a, but in the area 510 where the central heating amount is low, the third resistance part 331 and the pair of second terminals 302a and 302b may be arranged in a symmetrical pattern as shown, or in some cases, arranged in an asymmetrical pattern. The third connection parts 332 may be configured to compensate for heat generation by including patterns of various shapes, such as shapes including straight lines/curves with one or more folds, arc shapes, sine wave shapes, triangular wave shapes, and square wave shapes, thereby increasing a connection length.

Referring to FIGS. 4A to 4C, the heating element 114 of the susceptor 100 may include the main heating element 310 of the first layer and the second compensation heating element 330 of the second layer, which are arranged (embedded) in a stacked structure with a ceramic material therebetween within the insulation plate 110.

The main heating element 310 corresponds to a heating element located between and electrically connected to the pair of first terminals 301a and 301b. The second compensation heating element 330 corresponds to a heating element located between and electrically connected to the pair of second terminals 302a and 302b.

The main heating element 310 may include multiple concentric arc-shaped first resistance parts 311 and first connection parts 312 for connecting two concentric arc-shaped first resistance parts at different diameter positions among the multiple concentric arc-shaped first resistance parts 311. For example, the two concentric arc-shaped first resistance parts may include an n-th (n is a natural number) concentric arc-shaped resistance part and an (n+2)th concentric arc-shaped resistance part from the inner side (n=1, 2, 3, . . . ). In addition, the two concentric arc-shaped resistance parts may include an n-th and (n+1)th concentric arc-shaped resistance part in the outermost portion. Accordingly, by connecting the outermost arc-shaped resistance part to an adjacent arc-shaped resistance part, each arc-shaped resistance part may be electrically connected to configure a single heating zone by the main heating element 310.

It is desirable that a first virtual line 90 crossed by the first connection parts 312 extends in the diameter direction from the center of the insulation plate 110. The first virtual line 90 may correspond to a virtual line connecting the centers between the both end portions of concentric arc-shaped resistance parts 311 having the same diameter. The first connection parts 312 are configured obliquely with respect to the diameter direction and intersect a virtual line 90 connecting the centers between both end portions of the concentric arc-shaped first resistance parts 311 having the same diameter. Accordingly, a space between both end portions of the concentric arc-shaped first resistance parts 311 connected to the first connection parts 312 and a space including a portion therearound generate an area 500 with a relatively low heat generation amount. Additionally, the area 500 with a low heat generation amount may include the area 510 where the central heating amount is low. The area 510 with a low central heat generation amount may correspond to an area including one or more of the innermost resistance parts in the center among the first resistance parts 311 of the main heating body 310 (e.g., an area including two of the innermost resistance parts in the center in the drawing).

In the present disclosure, due to the “connection parts” connecting the “n-th concentric arc-shaped resistance part” and the “(n+2)th concentric arc-shaped resistance part” among two concentric arc-shaped elements at different diameter positions, the connection parts cross the virtual line 90, thereby preventing the temperature from dropping in the space between the both end portions of the arc-shaped resistance parts 311 and reducing temperature deviation. In other words, due to the aforementioned structure, there are no non-heating areas between the symmetrical folds of the conventional heating element pattern, thereby improving temperature uniformity across the entire upper surface area of the susceptor.

The second compensation heating element 330 may be arranged to be stacked above or below the main heating element 310 in the area 500 where the heat output is relatively low compared to the main heating element 310. The second compensation heating element 330 includes a third resistance part 331 which is stacked on and overlaps the first connection parts 312 of the main heating element 310, and includes a connection part 332 electrically connected to the pair of second terminals 302a and 302b and the both ends of the third resistance part 331. As such, the second compensation heating element 330 has a portion extending in the diameter direction so that at least a part thereof overlaps and is stacked with the first connection part 312 of the main heating element 310.

Both ends of the third resistance part 331 may be arranged to be close as possible, for example, within a predetermined distance such as 1 cm or 2 cm, to the pair of second terminals 302a and 302b, which are close to each other within a predetermined distance such as 1 cm or 2 cm. The third connection parts 332 (two connection parts) located between and connected to each of the both ends of the third resistance part 331, which is arranged in the area (510) with a low central heat generation amount, and the pair of second terminals 302a and 302b may have a symmetrical pattern as shown, but may also be arranged in an asymmetrical pattern depending on the case. The third connection parts 332 may be configured to compensate for heat generation by including patterns of various shapes, such as shapes including straight lines/curves with one or more folds, arc shapes, sine wave shapes, triangular wave shapes, and square wave shapes, thereby increasing a connection length.

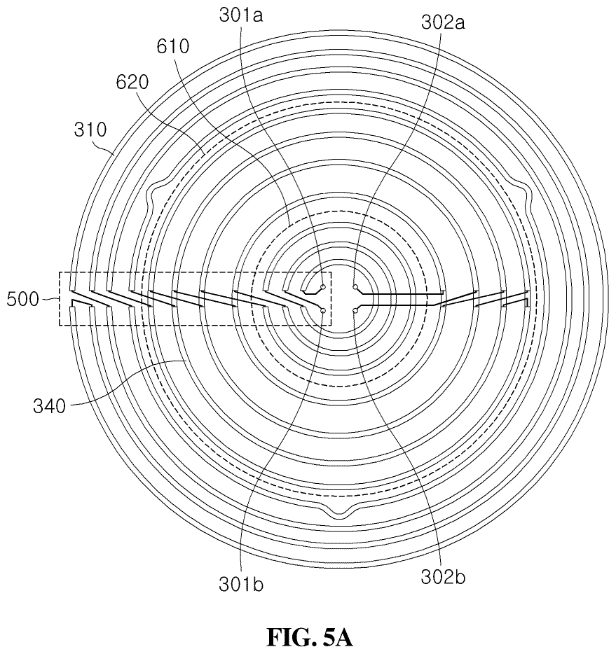

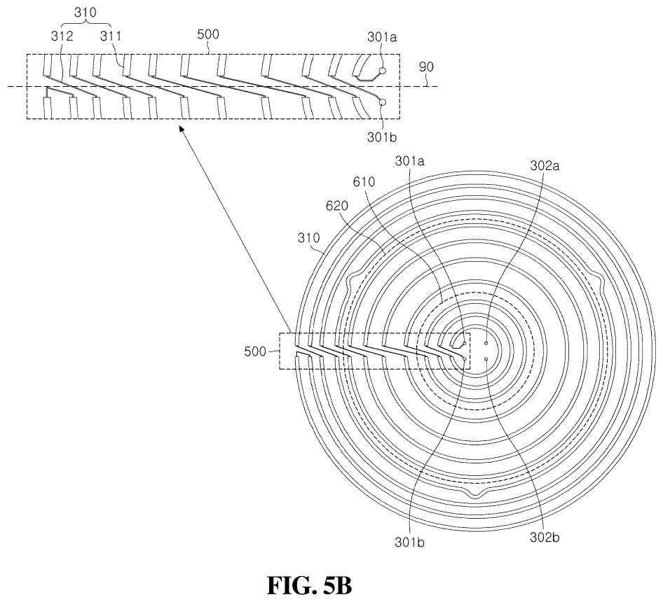

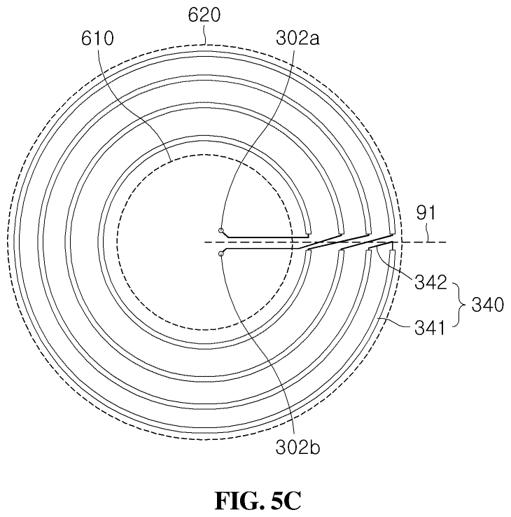

FIG. 5A is a plan view of stacked heating elements 310 and 340 of a third embodiment of the susceptor the present disclosure, and FIGS. 5B and 5C are enlarged views of a heating elements 310 and 340 for each layer in an area 610 or 620 with a low heat generation amount. In the drawing, it is preferable that the main heating element 310 be placed in a layer higher than the third compensation heating element 340, but in some cases, it is also possible for the main heating element 310 to be placed in a layer lower than the third compensation heating element 340. The third compensation heating element 340 may be applied to compensate for the heat generation in the area 610 and 620 (mainly, a middle part defining a band with a predetermined width in the diameter direction) of the main heating element 310, which has a relatively low heat generation amount, instead of the first compensation heating element 320 in FIG. 3A or the second compensation heating element 330 in FIG. 4A.

Referring to FIGS. 5A to 5C, the heating element 114 of the susceptor 100 may include the main heating element 310 of the first layer and the third compensation heating element 340 of the second layer, which are arranged (embedded) in a stacked structure with a ceramic material therebetween within the insulation plate 110.

The main heating element 310 corresponds to a heating element located between and electrically connected to the pair of first terminals 301a and 301b. The third compensation heating element 340 corresponds to a heating element located between and electrically connected to the pair of second terminals 302a and 302b.

The main heating element 310 may include multiple concentric arc-shaped first resistance parts 311 and first connection parts 312 for connecting two concentric arc-shaped first resistance parts at different diameter positions among the multiple concentric arc-shaped first resistance parts 311. For example, the two concentric arc-shaped resistance parts at different diameter positions may include an n-th (n is a natural number) concentric arc-shaped resistance part and an (n+2)th concentric arc-shaped resistance part from the inner side (n=1, 2, 3, . . . ). The two concentric arc-shaped resistance parts at different diameter positions may include an n-th and (n+1)th concentric arc-shaped resistance part in the outermost portion. Accordingly, by connecting the outermost arc-shaped resistance part to an adjacent arc-shaped resistance part, each arc-shaped resistance part may be electrically connected to configure a single heating zone by the main heating element 310. It is desirable that a first virtual line 90 crossed by the first connection parts 312 extends in the diameter direction from the center of the insulation plate 110. In the present disclosure, due to the “connection parts” connecting the “n-th concentric arc-shaped resistance part” and the “(n+2)th concentric arc-shaped resistance part” among two concentric arc-shaped elements at different diameter positions, the connection parts cross the virtual line 90, thereby preventing the temperature from dropping in the space between the both end portions of the arc-shaped resistance parts 311 and reducing temperature deviation. In other words, due to the aforementioned structure, there are no non-heating areas between the symmetrical folds of the conventional heating element pattern, thereby improving temperature uniformity across the entire upper surface area of the susceptor.

In FIGS. 3A and 4A, it has been described that the space between both end portions of the concentric arc-shaped first resistance parts 311 connected to the first connection parts 312 and the space including a portion therearound generate an area 500 with a relatively low heat generation amount. In a structure shown in FIGS. 5A to 5C, the third compensation heating element 340 is applied to compensate for the heat generated in a cool zone in the area 610 and 620. That is, the third compensation heating element 340 may be applied to compensate for the heat generated in the area 610 to 620 (mainly the middle part defining a band with a predetermined width in the diameter direction) of the main heating element 310, where the heat generation is relatively low. The area 610 and 620, where heat generation is compensated by the third compensation heating element 340, overlaps at least a portion of the area 500 with a low heat generation amount, thereby enabling heat generation in the overlapping portion to also be compensated.

The third compensation heating element 340 may be arranged to be stacked above or below the main heating element 310 in the area 610 and 620 where the heat output is relatively low compared to the main heating element 310. The third compensation heating element 340 includes multiple concentric arc-shaped fourth resistance parts 341 and fourth connection parts 342 for connecting two concentric arc-shaped fourth resistance parts 341 at different diameter positions among the multiple concentric arc-shaped fourth resistance parts 341. Here, for example, the two concentric arc-shaped resistance parts may include an n-th (n is a natural number) concentric arc-shaped resistance part and an (n+2)th concentric arc-shaped resistance part from the inner side (n=1, 2, 3, . . . ). The two concentric arc-shaped resistance parts may include an n-th and (n+1)th concentric arc-shaped resistance part in the outermost portion. Accordingly, by connecting the outermost arc-shaped resistance part to an adjacent arc-shaped resistance part, each arc-shaped resistance part may be electrically connected to configure a single heating zone. It is desirable that a second virtual line 91 crossed by the fourth connection parts 342 extends in the diameter direction from the center of the insulation plate 110. The second virtual line 91 may correspond to a virtual line connecting the centers between the both end portions of concentric arc-shaped fourth resistance parts 341 having the same diameter. The second virtual line 91 is not limited to a straight line, but may also be a bent line or a curved line, depending on the circumstances (the same applies below). The fourth connection parts 342 are configured obliquely with respect to the diameter direction and intersect a virtual line 91 connecting the centers between both end portions of the concentric arc-shaped fourth resistance parts 341 having the same diameter. In the present disclosure, due to the “connection parts” connecting the “n-th concentric arc-shaped resistance part” and the “(n+2)th concentric arc-shaped resistance part” among two concentric arc-shaped elements at different diameter positions, the connection parts cross the virtual line 91, thereby preventing the temperature from dropping in the space between the both end portions of the arc-shaped resistance parts 341 and reducing temperature deviation. In other words, due to the aforementioned structure, there are no non-heating areas between the symmetrical folds of the conventional heating element pattern, thereby improving temperature uniformity across the entire upper surface area of the susceptor.

In addition, the third compensation heating element 340 may be applied to compensate for the heat generated in the area 610 to 620 (mainly the middle part defining a band with a predetermined width in the diameter direction) of the main heating element 310, where the heat generation is relatively low.

In the third compensation heating element 340, it is preferable that some concentric arc-shaped first resistance parts 311 (fourth to seventh resistance parts from the center shown in the example of FIG. 5A) of the main heating element 310 and the corresponding concentric arc-shaped fourth resistance parts 341 of the third compensation heating element 340 are stacked in an overlapping manner in the band area 610 and 620 within a predetermined diameter range (the middle part configuring a band within a predetermined width in the diameter direction). However, without limitation thereto, in some cases, it is also possible to arrange some concentric arc-shaped first resistance parts 311 (the fourth to seventh resistance parts from the center shown in the example of FIG. 5A) of the main heating element 310 and the corresponding concentric arc-shaped fourth resistance parts of the third compensation heating element 340 not to overlap each other.

As shown in FIGS. 5B and 5C, it is preferred that at least a portion of a first virtual line 90 crossed by first connection parts 312 of the main heating element 310 and a second virtual line 91 crossed by fourth connection parts 342 of the third compensation heating element 340 extend in different diameter directions from each other. In the drawings, the different diameter directions are shown as being positioned at 180-degree angles relative to the center, but depending on circumstances, the different diameter directions may be positioned at angles such as 90 degrees or 270 degrees with respect to the virtual lines 90 and 91.

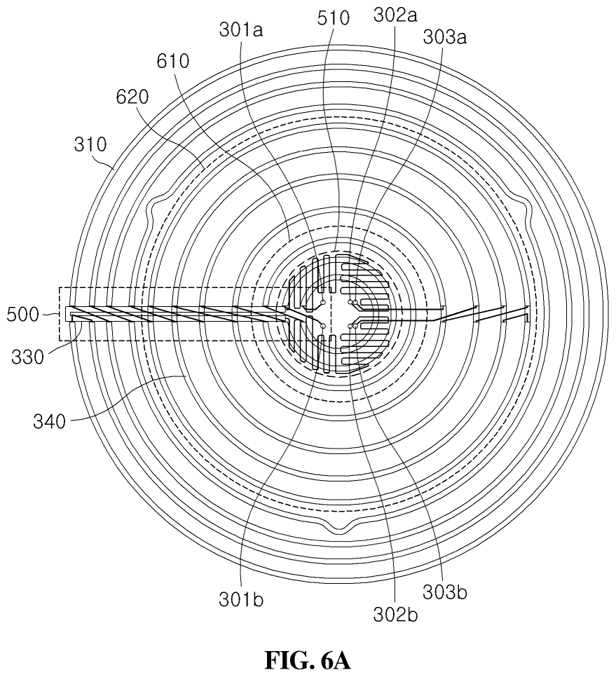

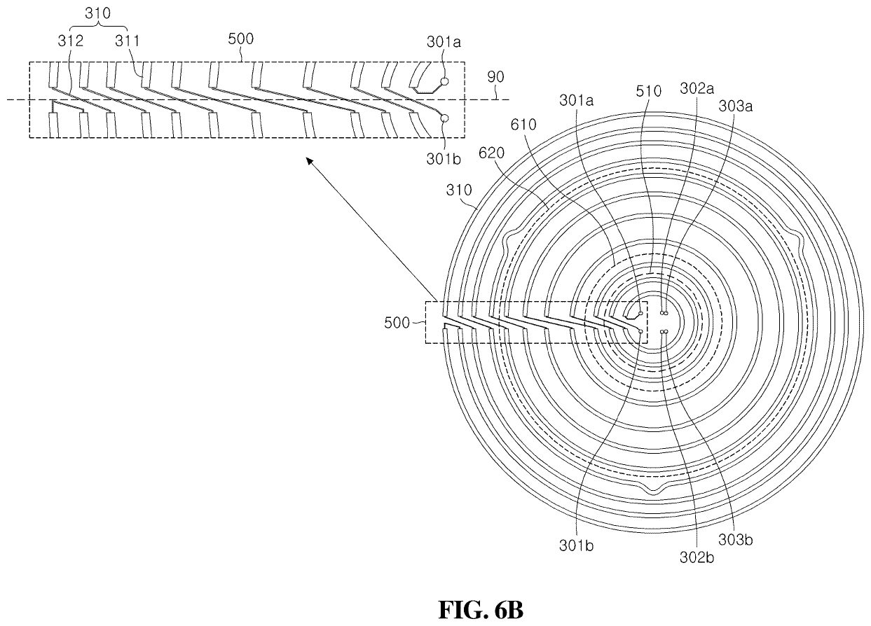

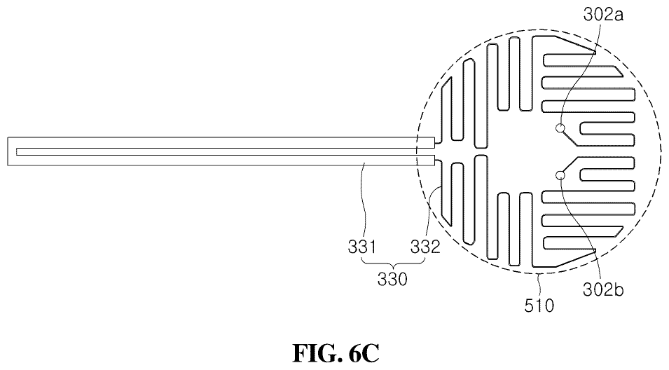

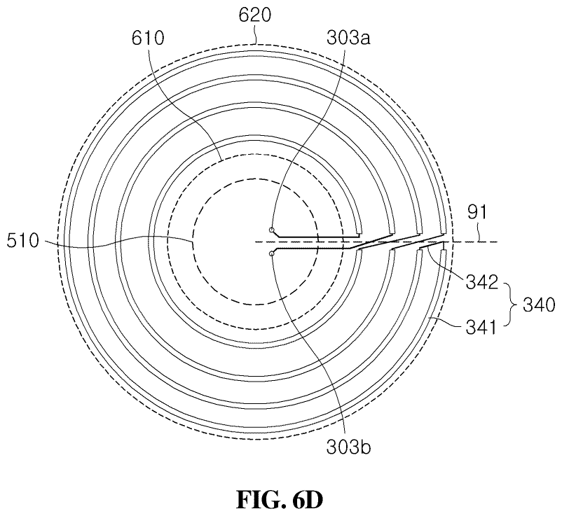

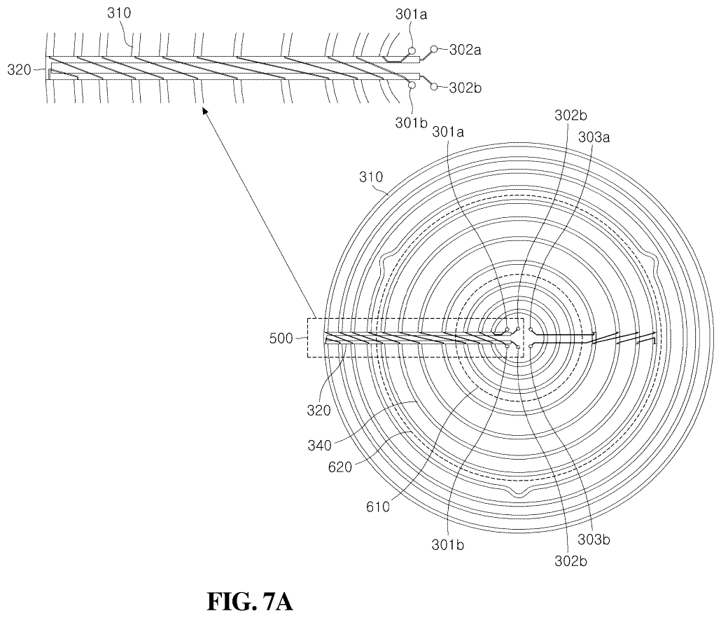

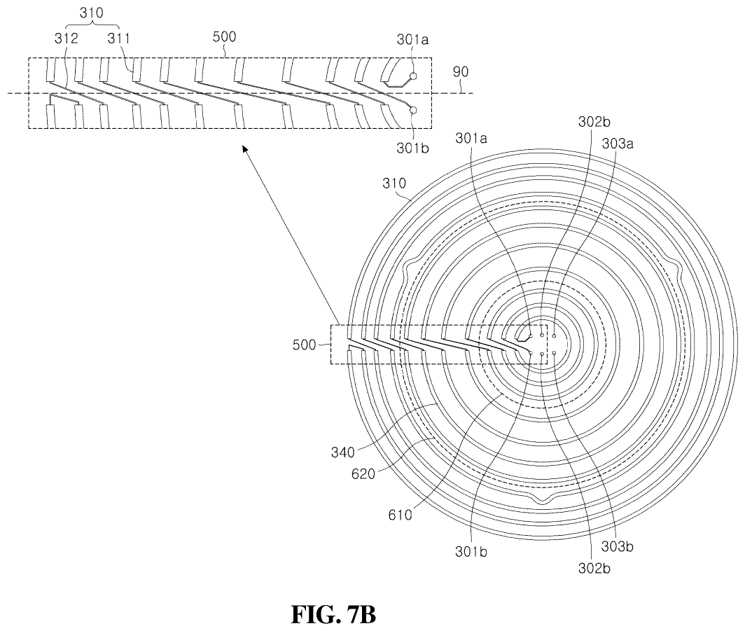

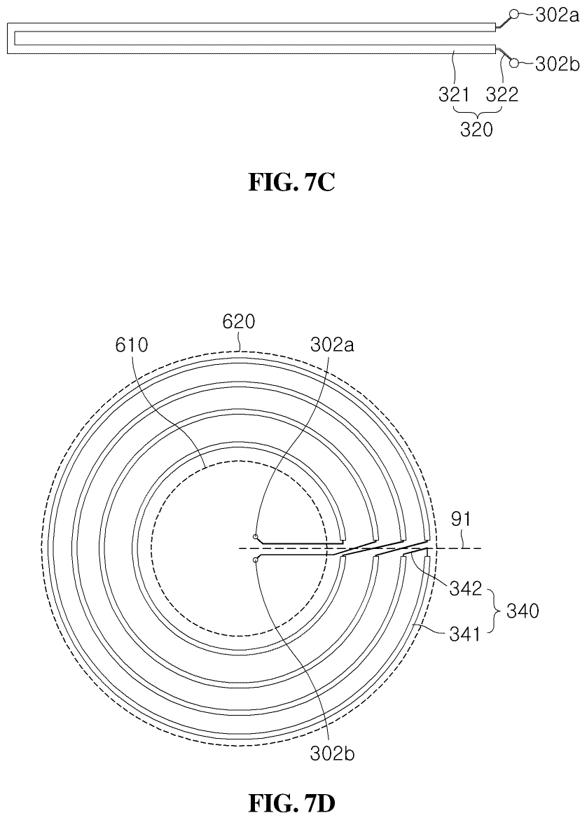

FIG. 6A is a plan view of stacked heating elements 310, 330, and 340 of a fourth embodiment of the present disclosure, and FIGS. 6B to 6D are enlarged views of heating elements for each layer in an area 500, 610, or 620 with a low heat generation amount. Here, in addition to the main heating element 310, a structure in which the second compensation heating element 330 shown in FIG. 4C and the third compensation heating element 340 shown in FIG. 5C are stacked on different layers will be described. Furthermore, in addition to the main heating element 310, a structure in which the first compensation heating element 320 of FIG. 3C and the third compensation heating element 340 of FIG. 5C are stacked on different layers is possible, which may be understood by referring to the explanations in FIGS. 7A to 7D.

The drawing shows an example of sequential stacking of the third compensation heating element 340, the second compensation heating element 330, and the main heating element 310 from the bottom layer on the shaft 120 side, but any combination of the stacking order of the third compensation heating element 340, the second compensation heating element 330, and the main heating element 310 is possible. The second compensation heating element 330 may be applied to compensate for the heat generation in the area 500 with a relatively low heat generation amount in the main heating element 310 due to the first connection parts 312, and the third compensation heating element 340 may be applied to compensate for the heat generation in another area 610 and 620 (mainly, the middle part defining a band with a predetermined width in the diameter direction) in the main heating element 310.

Referring to FIGS. 6A to 6D, the heating element 114 of the susceptor 100 may include the main heating element 310 of the first layer, the second compensation heating element 330 of the second layer, and the third compensation heating element 340 of the third layer, which are arranged (embedded) in a stacked structure with a ceramic material therebetween within the insulation plate 110.

The main heating element 310 corresponds to a heating element located between and electrically connected to the pair of first terminals 301a and 301b. The second compensation heating element 330 corresponds to a heating element located between and electrically connected to the pair of second terminals 302a and 302b. The third compensation heating element 340 corresponds to a heating element located between and electrically connected to the pair of third terminals 303a and 303b.

The main heating element 310 may include multiple concentric arc-shaped first resistance parts 311 and first connection parts 312 for connecting two concentric arc-shaped first resistance parts at different diameter positions among the multiple concentric arc-shaped first resistance parts 311. For example, the two concentric arc-shaped resistance parts may include an n-th (n is a natural number) concentric arc-shaped resistance part and an (n+2)th concentric arc-shaped resistance part from the inner side (n=1, 2, 3, . . . ). The two concentric arc-shaped resistance parts may include an n-th and (n+1)th concentric arc-shaped resistance part in the outermost portion. Accordingly, by connecting the outermost arc-shaped resistance part to an adjacent arc-shaped resistance part, each arc-shaped resistance part may be electrically connected to configure a single heating zone by the main heating element 310. It is desirable that a first virtual line 90 crossed by the first connection parts 312 extends in the diameter direction from the center of the insulation plate 110. The first virtual line 90 may correspond to a virtual line connecting the centers between the both end portions of concentric arc-shaped first resistance parts 311 having the same diameter. The first connection parts 312 are configured obliquely with respect to the diameter direction and intersect a virtual line 90 connecting the centers between both end portions of the concentric arc-shaped resistance parts 311 having the same diameter.

In addition, a space between both end portions of the concentric arc-shaped resistance parts 311 connected to the first connection parts 312 and a space including a portion therearound generate an area 500 with a relatively low heat generation amount. Additionally, the area 500 with a low heat generation amount may include the area 510 where the central heating amount is low. The area 510 with a low central heat generation amount may correspond to an area including one or more of the innermost resistance parts in the center among the resistance parts 311 of the main heating body 310 (e.g., an area including two of the innermost resistance parts in the center in the drawing).

In the present disclosure, due to the “connection parts” connecting the “n-th concentric arc-shaped resistance part” and the “(n+2)th concentric arc-shaped resistance part” among two concentric arc-shaped elements at different diameter positions, the connection parts cross the virtual line 90, thereby preventing the temperature from dropping in the space between the both end portions of the arc-shaped resistance parts 311 and reducing temperature deviation. In other words, due to the aforementioned structure, there are no non-heating areas between the symmetrical folds of the conventional heating element pattern, thereby improving temperature uniformity across the entire upper surface area of the susceptor.

The second compensation heating element 330 may be arranged to be stacked above or below the main heating element 310 in the area 500 where the heat output is relatively low compared to the main heating element 310. The second compensation heating element 330 includes a third resistance part 331 which is stacked on and overlaps the first connection parts 312 of the main heating element 310, and includes a connection part 332 electrically connected to the pair of second terminals 302a and 302b and the both ends of the third resistance part 331. As such, the second compensation heating element 330 has a portion extending in the diameter direction so that at least a part thereof overlaps and is stacked with the first connection part 312 of the main heating element 310.

Both ends of the third resistance part 331 may be arranged to be close as possible, for example, within a predetermined distance such as 1 cm or 2 cm, to the pair of second terminals 302a and 302b, which are close to each other within a predetermined distance such as 1 cm or 2 cm. The third connection parts 332 (two connection parts) located between and connected to each of the both ends of the third resistance part 331, which is arranged in the area (510) with a low central heat generation amount, and the pair of second terminals 302a and 302b may have a symmetrical pattern as shown, but may also be arranged in an asymmetrical pattern depending on the case. The third connection parts 332 may be configured to compensate for heat generation by including patterns of various shapes, such as shapes including straight lines/curves with one or more folds, arc shapes, sine wave shapes, triangular wave shapes, and square wave shapes, thereby increasing a connection length.

The third compensation heating element 340 may be arranged to be stacked above or below the main heating element 310 in the area 610 and 620 where the heat output is relatively low compared to the main heating element 310, and the third compensation heating element 340 may be arranged to be stacked above or below the first and second compensation heating element 320, 330. The third compensation heating element 340 includes multiple concentric arc-shaped fourth resistance parts 341 and fourth connection parts 342 for connecting two concentric arc-shaped fourth resistance parts 341 at different diameter positions among the multiple concentric arc-shaped resistance parts 341. Here, for example, the two concentric arc-shaped fourth resistance parts may include an n-th (n is a natural number) concentric arc-shaped fourth resistance part and an (n+2)th concentric arc-shaped fourth resistance part from the inner side (n=1, 2, 3, . . . ). The two concentric arc-shaped resistance parts may include an n-th and (n+1)th concentric arc-shaped resistance part in the outermost portion. Accordingly, by connecting the outermost arc-shaped resistance part to an adjacent arc-shaped resistance part, each arc-shaped resistance part may be electrically connected to configure a single heating zone. It is desirable that a second virtual line 91 crossed by the fourth connection parts 342 extends in the diameter direction from the center of the insulation plate 110.

The third compensation heating element 340 may be applied to compensate for the heat generated in the area 610 to 620 (mainly the middle part defining a band with a predetermined width in the diameter direction) of the main heating element 310, where the heat generation is relatively low.

In the third compensation heating element 340, it is preferable that some concentric arc-shaped first resistance parts 311 (fourth to seventh resistance parts from the center shown in the example of FIG. 6A) of the main heating element 310 and the corresponding concentric arc-shaped fourth resistance parts 341 of the third compensation heating element 340 are stacked in an overlapping manner in the band area 610 and 620 within a predetermined diameter range (the middle part configuring a band with a predetermined width in the diameter direction). However, without limitation thereto, in some cases, it is also possible to arrange some concentric arc-shaped first resistance parts 311 (the fourth to seventh resistance parts from the center shown in the example of FIG. 6A) of the main heating element 310 and the corresponding concentric arc-shaped fourth resistance parts of the third compensation heating element 340 not to overlap each other. It is preferred that the connection part 332 of the second compensation heating element 330 be arranged in the inner region in the diameter direction with respect to the band area 610 and 620.

As shown in FIGS. 6A and 6D, it is preferred that at least a portion of a first virtual line 90 crossed by first connection parts 312 of the main heating element 310 and a second virtual line 91 crossed by fourth connection parts 342 of the third compensation heating element 340 extend in different diameter directions from each other. In the drawings, the different diameter directions are shown as being positioned at 180-degree angles relative to the center, but depending on circumstances, the different diameter directions may be positioned at angles such as 90 degrees or 270 degrees with respect to the virtual lines 90 and 91. FIG. 7A is a plan view of stacked heating elements 310, 320, and 340 of a fifth embodiment of the susceptor of the present disclosure, and FIGS. 7B to 7D are enlarged views of heating elements for each layer in an area 500, 610, or 620 with a low heat generation amount. Here, in addition to the main heating element 310, a structure in which the first compensation heating element 320 shown in FIG. 3C and the third compensation heating element 340 shown in FIG. 5C are stacked on different layers will be described.

The drawing shows an example of sequential stacking of the third compensation heating element 340, the first compensation heating element 320, and the main heating element 310 from the bottom layer on the shaft 120 side, but any combination of the stacking order of the third compensation heating element 340, the first compensation heating element 320, and the main heating element 310 is possible. The first compensation heating element 320 may be applied to compensate for the heat generation in the area 500 with a relatively low heat generation amount in the main heating element 310 due to the first connection parts 312, and the third compensation heating element 340 may be applied to compensate for the heat generation in another area 610 and 620 (mainly, the middle part defining a band with a predetermined width in the diameter direction) in the main heating element 310.

Referring to FIGS. 7A to 7D, the heating element 114 of the susceptor 100 may include the main heating element 310 of the first layer, the first compensation heating element 320 of the second layer, and the third compensation heating element 340 of the third layer, which are arranged (embedded) in a stacked structure with a ceramic material therebetween within the insulation plate 110.

The main heating element 310 corresponds to a heating element located between and electrically connected to the pair of first terminals 301a and 301b. The first compensation heating element 320 corresponds to a heating element located between and electrically connected to the pair of second terminals 302a and 302b. The third compensation heating element 340 corresponds to a heating element located between and electrically connected to the pair of third terminals 303a and 303b.

The main heating element 310 may include multiple concentric arc-shaped first resistance parts 311 and first connection parts 312 for connecting two concentric arc-shaped first resistance parts at different diameter positions among the multiple concentric arc-shaped first resistance parts 311. For example, the two concentric arc-shaped resistance parts may include an n-th (n is a natural number) concentric arc-shaped resistance part and an (n+2)th concentric arc-shaped resistance part from the inner side (n=1, 2, 3, . . . ). The two concentric arc-shaped resistance parts may include an n-th and (n+1)th concentric arc-shaped resistance part in the outermost portion. Accordingly, by connecting the outermost arc-shaped resistance part to an adjacent arc-shaped resistance part, each arc-shaped resistance part may be electrically connected to configure a single heating zone by the main heating element 310. It is desirable that a first virtual line 90 crossed by the first connection parts 312 extends in the diameter direction from the center of the insulation plate 110. The first virtual line 90 may correspond to a virtual line connecting the centers between the both end portions of concentric arc-shaped first resistance parts 311 having the same diameter. The first connection parts 312 are configured obliquely with respect to the diameter direction and intersect a virtual line 90 connecting the centers between both end portions of the concentric arc-shaped first resistance parts 311 having the same diameter. Accordingly, a space between both end portions of the concentric arc-shaped first resistance parts 311 connected to the first connection parts 312 and a space including a portion therearound generate an area 500 with a relatively low heat generation amount.

In the present disclosure, due to the “connection parts” connecting the “n-th concentric arc-shaped resistance part” and the “(n+2)th concentric arc-shaped resistance part” among two concentric arc-shaped elements at different diameter positions, the connection parts cross the virtual line 90, thereby preventing the temperature from dropping in the space between the both end portions of the arc-shaped resistance parts 311 and reducing temperature deviation. In other words, due to the aforementioned structure, there are no non-heating areas between the symmetrical folds of the conventional heating element pattern, thereby improving temperature uniformity across the entire upper surface area of the susceptor.

The first compensation heating element 320 may be arranged to be stacked above or below the main heating element 310 in the area 500 where the heat output is relatively low compared to the main heating element 310. The first compensation heating element 320 includes a second resistance part 321 which is stacked on and overlaps the first connection parts 312 of the main heating element 310, and includes a second connection part 322 electrically connected to the pair of second terminals 302a and 302b and the both ends of the second resistance part 321. As such, the first compensation heating element 320 has a portion extending in the diameter direction so that at least a part thereof overlaps and is stacked with the first connection part 312 of the main heating element 310.

Both ends of the second resistance part 321 are brought as close as possible, for example, within a predetermined distance such as 1 cm or 2 cm, to the pair of second terminals 302a and 302b, which are close to each other within a predetermined distance such as 1 cm or 2 cm, and each second connection part 322 at both ends of the second resistance part 321 is connected in a straight line or curved line (e.g., a curve is possible without a bend of 90 degrees or more) without folding.

The third compensation heating element 340 may be arranged to be stacked above or below the main heating element 310 in the area 610 and 620 where the heat output is relatively low compared to the main heating element 310, and the third compensation heating element 340 may be arranged to be stacked above or below the first compensation heating element 320. The third compensation heating element 340 includes multiple concentric arc-shaped fourth resistance parts 341 and fourth connection parts 342 for connecting two concentric arc-shaped resistance parts at different diameter positions among the multiple concentric arc-shaped fourth resistance parts 341. Here, for example, the two concentric arc-shaped resistance parts may include an n-th (n is a natural number) concentric arc-shaped resistance part and an (n+2)th concentric arc-shaped resistance part from the inner side (n=1, 2, 3, . . . ). The two concentric arc-shaped resistance parts may include an n-th and (n+1)th concentric arc-shaped resistance part in the outermost portion. Accordingly, by connecting the outermost arc-shaped resistance part to an adjacent arc-shaped resistance part, each arc-shaped resistance part may be electrically connected to configure a single heating zone. It is desirable that a second virtual line 91 crossed by the fourth connection parts 342 extends in the diameter direction from the center of the insulation plate 110. In the present disclosure, due to the “connection parts” connecting the “n-th concentric arc-shaped resistance part” and the “(n+2)th concentric arc-shaped resistance part” among two concentric arc-shaped elements at different diameter positions, the connection parts cross the virtual line 91, thereby preventing the temperature from dropping in the space between the both end portions of the arc-shaped resistance parts 341 and reducing temperature deviation. In other words, due to the aforementioned structure, there are no non-heating areas between the symmetrical folds of the conventional heating element pattern, thereby improving temperature uniformity across the entire upper surface area of the susceptor.

The third compensation heating element 340 may be applied to compensate for the heat generated in the area 610 to 620 (mainly the middle part defining a band with a predetermined width in the diameter direction) of the main heating element 310, where the heat generation is relatively low.

In the third compensation heating element 340, it is preferable that some concentric arc-shaped first resistance parts 311 (fourth to seventh resistance parts from the center shown in the example of FIG. 7A) of the main heating element 310 and the corresponding concentric arc-shaped fourth resistance parts 341 of the third compensation heating element 340 are stacked in an overlapping manner in the band area 610 and 620 within a predetermined diameter range (the middle part configuring a band with a predetermined width in the diameter direction). However, without limitation thereto, in some cases, it is also possible to arrange some concentric arc-shaped first resistance parts 311 (the fourth to seventh resistance parts from the center shown in the example of FIG. 7A) of the main heating element 310 and the corresponding concentric arc-shaped fourth resistance parts of the third compensation heating element 340 not to overlap each other. It is preferred that the second connection part 322 of the first compensation heating element 320 be arranged in the inner region in the diameter direction with respect to the band area 610 and 620.

As shown in FIGS. 7A and 7D, it is preferred that at least a portion of a first virtual line 90 crossed by first connection parts 312 of the main heating element 310 and a second virtual line 91 crossed by fourth connection parts 342 of the third compensation heating element 340 extend in different diameter directions from each other. In the drawings, the different diameter directions are shown as being positioned at 180-degree angles relative to the center, but depending on circumstances, the different diameter directions may be positioned at angles such as 90 degrees or 270 degrees with respect to the virtual lines 90 and 91.

As described above, the susceptor 100 according to an embodiment of the present disclosure does not have a straight connection line parts (a connection part for connecting a terminal and a resistance part) of a very long non-heating area (non-heating area between symmetrical folds in the heating element pattern) in the heating element 114, which normally generates two heating zones (2 zones), thereby improving temperature uniformity across the entire upper surface area of the susceptor and improving durability over long-term use of the susceptor. Furthermore, the susceptor 100 of the present disclosure has a main heating element 310 of the heating element 114 in an ideal concentric circle shape, which may significantly reduce the possibility of temperature differences occurring between locations of the same diameter on the upper surface of the susceptor 100.

Furthermore, the susceptor 100 of the present disclosure configures a main heating element 310 and an additional compensation heating element 320, 330, or 340 stacked on a different plane (layer) to compensate for temperature distribution, and configures an additional temperature compensation heating element for an area where straight connection line parts for connecting heating elements at different diameter positions exist in the main heating element 310, or for an area 500, 610, or 620 with relatively low heat generation in the main heating element 310 to further improve temperature uniformity across the entire upper surface area of the susceptor 100.

As such, in the present disclosure, specific matters such as specific components, etc., and limited embodiments and drawings have been described, but these are only provided to help a more general understanding of the present disclosure, and the present disclosure is not limited to the above embodiments. Those of ordinary skill in the field to which the present disclosure pertains will be able to make various modifications and variations without departing from the essential characteristics of the present disclosure. Therefore, the spirit of the disclosure should not be limited to the above-described embodiments, and it should be construed that the following claims as well as all technical ideas modified equally or equivalently to the claims are intended to fall within the scope and spirit of the disclosure.

What is claimed is:

1. A susceptor comprising an insulation plate on which a first heating element of a first layer and a second heating element of a second layer are arranged and stacked,
wherein the first heating element is located between and connected to a pair of first terminals, and the second heating element is located between and connected to a pair of second terminals,
wherein the first heating element comprises multiple concentric arc-shaped first resistance parts and first connection parts configured to connect the resistance parts at different diameter positions, and
wherein at least one of the first connection parts crosses a virtual line configured to connect centers between both end portions of each of the first resistance parts.

2. The susceptor of claim 1, wherein the second heating element is arranged above or below the first heating element.

3. The susceptor of claim 1, wherein the second heating element comprises a first compensation heating element extending in a diameter direction so that at least a portion of the first compensation heating element is stacked to overlap the first connection parts of the first heating element.

4. The susceptor of claim 3, wherein the first compensation heating element comprises a second resistance part overlapping the first connection parts, and second connection parts located between and connected to the pair of second terminals and both ends of the second resistance part.

5. The susceptor of claim 4, wherein the second connection parts located between and connected to both ends of the second resistance part has a straight or curved shape without folds.

6. The susceptor of claim 1, wherein the second heating element comprises a second compensation heating element extending in a diameter direction so that at least a portion of the second compensation heating element is stacked to overlap the first connection parts of the first heating element, and
wherein the second compensation heating element comprises a third resistance part overlapping the first connection parts, and third connection parts located between and connected to the pair of second terminals and both ends of the third resistance part, wherein the third connection parts located between and connected to both ends of the third resistance part and the pair of second terminals comprise a pattern having at least one fold.

7. The susceptor of claim 1, wherein the second heating element comprises a third compensation heating element comprising multiple concentric arc-shaped fourth resistance parts and fourth connection parts configured to connect two concentric arc-shaped fourth resistance parts at different diameter positions among the multiple concentric arc-shaped fourth resistance parts.

8. The susceptor of claim 7, wherein some of the concentric arc-shaped first resistance parts of the first heating element and corresponding concentric arc-shaped fourth resistance parts of the third compensation heating element are stacked to overlap each other in a band-shaped region within a predetermined diameter range.

9. The susceptor of claim 7, wherein a first virtual line configured to connect centers between both end portions of the first resistance parts of the first heating element and a second virtual line configured to connect centers between both end portions of the fourth resistance parts of the third compensation heating element have at least a portion of each extending in different diameter directions.

10. The susceptor of claim 3, wherein the insulation plate further comprises a third compensation heating element stacked on a third layer, and
wherein the third compensation heating element comprises multiple concentric arc-shaped fourth resistance parts and fourth connection parts configured to connect two concentric arc-shaped fourth resistance parts at different diameter positions among the multiple concentric arc-shaped fourth resistance parts.

11. The susceptor of claim 10, wherein some of the concentric arc-shaped first resistance parts of the first heating element and corresponding concentric arc-shaped fourth resistance parts of the third compensation heating element are stacked to overlap each other in a band-shaped region within a predetermined diameter range.

12. The susceptor of claim 10, wherein a first virtual line configured to connect centers between both end portions of the first resistance parts of the first heating element and a second virtual line configured to connect centers between both end portions of the fourth resistance parts of the third compensation heating element have at least a portion of each extending in different diameter directions.

13. The susceptor of claim 6, wherein the insulation plate further comprises a third compensation heating element stacked on a third layer, and
wherein the third compensation heating element comprises multiple concentric arc-shaped fourth resistance parts and fourth connection parts configured to connect two concentric arc-shaped fourth resistance parts at different diameter positions among the multiple concentric arc-shaped fourth resistance parts.
